(19) United States
(12) Patent Application Publication
(10) Pub. No.: US 2024/0015332 A1
(43) Pub. Date: Jan. 11, 2024

(54) SUPPLEMENTAL ENHANCEMENT INFORMATION (SEI) MANIFEST INDICATION

(71) Applicant: QUALCOMM Incorporated, San Diego, CA (US)

(72) Inventors: Yong He, San Diego, CA (US); Muhammed Zeyd Coban, Carlsbad, CA (US)

(21) Appl. No.: 18/332,098

(22) Filed: Jun. 9, 2023

Related U.S. Application Data
(60) Provisional application No. 63/481,896, filed on Jan. 27, 2023.
(60) Provisional application No. 63/382,004, filed on Nov. 2, 2022.
(60) Provisional application No. 63/378,789, filed on Oct. 7, 2022.
(60) Provisional application No. 63/367,973, filed on Jul. 8, 2022.

(51) Int. Cl. H04N 19/70

(52) U.S. Cl. CPC H04N 19/70

(57) ABSTRACT

A video decoder may receive a supplemental enhancement information (SEI) processing order SEI message, decode a syntax element in the SEI processing order SEI message that indicates a preferred processing order of SEI messages in a bitstream, and process the SEI message present in the bitstream in accordance with the preferred processing order.

This application claims the benefit of U.S. Provisional Application No. 63/367,973, filed Jul. 8, 2022, U.S. Provisional Application No. 63/378,789, filed Oct. 7, 2022, U.S. Provisional Application No. 63/382,004, filed Nov. 2, 2022, and U.S. Provisional Application No. 63/481,896, filed Jan. 27, 2023, the entire content of each of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for encoding and decoding video data, including techniques for encoding and decoding syntax elements in a supplemental enhancement information (SEI) processing order SEI message. The techniques of this disclosure include coding an manifest SEI payload type syntax element (e.g., manifest seipayload type) that indicates a preferred ordering of processing SEI messages. This disclosure also describes techniques for coding an SEI processing order SEI message that includes coding one or more syntax elements that indicate the processing order for particular syntax elements. Processing SEI message according to the preferred ordering may improve user experience and video coder performance, including in uses cases that include a neural-network post filter and/or a film grain synthesis process.

In one example, this disclosure describes a method of processing video data including receiving an SEI processing order SEI message, decoding a first syntax element in the SEI processing order SEI message, the first syntax element indicating a preferred processing order of a first SEI message present in a bitstream, decoding a second syntax element in the SEI processing order SEI message, the second syntax element indicating the preferred processing order of a second SEI message present in the bitstream, wherein the first syntax element and the second syntax element have different values, and processing the first SEI message and the second SEI message in accordance with the preferred processing order.

In another example, this disclosure describes an apparatus configured to process video data, the apparatus comprising a memory configured to store the video data, and one or more processors coupled to the memory, wherein the apparatus is configured to receive an SEI processing order SEI message, decode a first syntax element in the SEI processing order SEI message, the first syntax element indicating a preferred processing order of a first SEI message present in a bitstream, decode a second syntax element in the SEI processing order SEI message, the second syntax element indicating the preferred processing order of a second SEI message present in the bitstream, wherein the first syntax element and the second syntax element have different values, and process the first SEI message and the second SEI message in accordance with the preferred processing order.

In another example, this disclosure describes an apparatus configured to process video data, the apparatus comprising means for receiving an SEI processing order SEI message, means for decoding a first syntax element in the SEI processing order SEI message, the first syntax element indicating a preferred processing order of a first SEI message present in a bitstream, means for decoding a second syntax element in the SEI processing order SEI message, the second syntax element indicating the preferred processing order of a second SEI message present in the bitstream, wherein the first syntax element and the second syntax element have different values, and means for processing the first SEI message and the second SEI message in accordance with the preferred processing order.

In another example, this disclosure describes a non-transitory computer-readable storage medium storing instructions that, when executed, cause one or more processors configured to process video data to receive an SEI processing order SEI message, decode a first syntax element in the SEI processing order SEI message, the first syntax element indicating a preferred processing order of a first SEI message present in a bitstream, decode a second syntax element in the SEI processing order SEI message, the second syntax element indicating the preferred processing order of a second SEI message present in the bitstream, wherein the first syntax element and the second syntax element have different values, and process the first SEI message and the second SEI message in accordance with the preferred processing order.

In another example, this disclosure describes a method of processing video data, the method comprising generating an SEI processing order SEI message, encoding a first syntax element in the SEI processing order SEI message, the first syntax element indicating a preferred processing order of a first SEI message present in a bitstream, and encoding a second syntax element in the SEI processing order SEI message, the second syntax element indicating the preferred processing order of a second SEI message present in the bitstream, wherein the first syntax element and the second syntax element have different values.

In another example, this disclosure describes an apparatus configured to process video data, the apparatus comprising a memory configured to store the video data, and one or more processors coupled to the memory, wherein the apparatus is configured to generate an SEI processing order SEI message, encode a first syntax element in the SEI processing order SEI message, the first syntax element indicating a preferred processing order of a first SEI message present in a bitstream, and encode a second syntax element in the SEI processing order SEI message, the second syntax element indicating the preferred processing order of a second SEI message present in the bitstream, wherein the first syntax element and the second syntax element have different values.

In another example, this disclosure describes an apparatus configured to process video data, the apparatus comprising means for generating an SEI processing order SEI message, means for encoding a first syntax element in the SEI processing order SEI message, the first syntax element indicating a preferred processing order of a first SEI message present in a bitstream, and means for encoding a second syntax element in the SEI processing order SEI message, the second syntax element indicating the preferred processing order of a second SEI message present in the bitstream, wherein the first syntax element and the second syntax element have different values.

In another example, this disclosure describes a non-transitory computer-readable storage medium storing instructions that, when executed, cause one or more processors configured to process video data to generate an SEI processing order SEI message, encode a first syntax element in the SEI processing order SEI message, the first syntax element indicating a preferred processing order of a first SEI message present in a bitstream, and encode a second syntax element in the SEI processing order SEI message, the second syntax element indicating the preferred processing order of a second SEI message present in the bitstream, wherein the first syntax element and the second syntax element have different values.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a flowchart illustrating an example method for processing an SEI manifest SEI message in accordance with the techniques of this disclosure.

FIG. 7 is a flowchart illustrating an example method for decoding an SEI processing order SEI message in accordance with the techniques of this disclosure.

FIG. 8 is a flowchart illustrating an example method for encoding an SEI processing order SEI message in accordance with the techniques of this disclosure.

### DETAILED DESCRIPTION

A Supplemental Enhancement Information (SEI) message is a type of data structure used in video coding. The SEI message is not used to carry video or audio data itself. Instead, the SEI message contains metadata that provides additional information about the encoded video stream. This information can be used to enhance the quality of the decoded video, indicate preferred output processes, provide information about the encoded video stream, or for other purposes. Some example types of SEI messages may include information about the initial buffering time required before starting the playback of the video, timing information related to the current picture in the video stream, information on how to display the video when the aspect ratio of the video does not match the aspect ratio of the display, information indicating if the video needs to be rotated or flipped before being displayed, and other types of information.

SEI messages may be inserted into the video stream by the encoder and then can be interpreted and acted upon by the decoder. However, the decoding of SEI messages is typically not required for decoding the video stream. SEI messages allow for a wide range of video enhancements and additional features to be implemented without changing the core video encoding and decoding process.

In some example video codecs, an SEI manifest SEI message may be encoded and sent in the encoded video bitstream. An SEI manifest SEI message conveys information on SEI messages that are indicated as expected (e.g., likely) to be present or not present in an encoded video bitstream. Prior SEI manifest SEI message lists the SEI messages present in the bitstream, but does not indicate any processing order of the bitstream. The techniques of this disclosure include coding an SEI manifest payload type syntax element (e.g., manifest seipayload type) that indicates a preferred ordering of processing SEI messages. This disclosure also describes techniques for coding an SEI processing order SEI message that includes coding one or more syntax elements that indicate the processing order for particular syntax elements. Processing SEI message according to the preferred ordering may improve user experience and video coder performance, including in uses cases that include a neural-network post filter and/or a film grain synthesis process.

In one example, a video decoder may be configured to receive an SEI processing order SEI message, decode a first syntax element in the SEI processing order SEI message, the first syntax element indicating a preferred processing order of a first SEI message present in a bitstream, decode a second syntax element in the SEI processing order SEI message, the second syntax element indicating the preferred processing order of a second SEI message present in the bitstream, wherein the first syntax element and the second syntax element have different values, and process the first SEI message and the second SEI message in accordance with the preferred processing order.

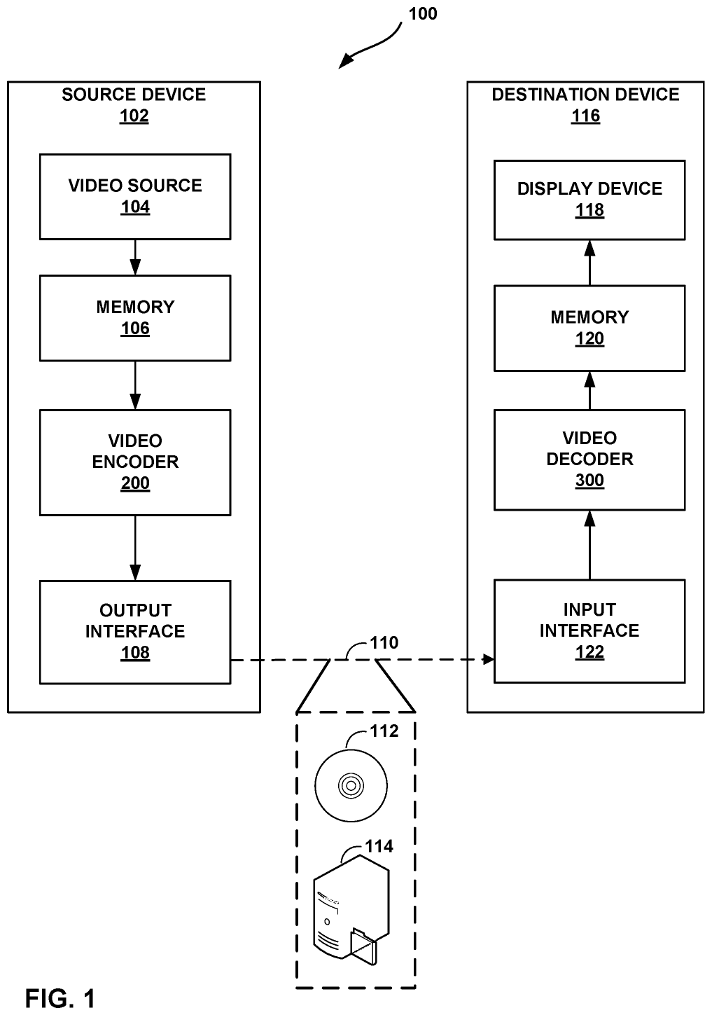

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for processing SEI messages. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for processing SEI messages. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use SEI messages.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV 1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an rn-bit value during quantization, where n is greater than rn. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block. This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, as will be explained in more detail below, video decoder 300 may be configured to receive an SEI processing order SEI message, decode a first syntax element in the SEI processing order SEI message, the first syntax element indicating a preferred processing order of a first SEI message present in a bitstream, decode a second syntax element in the SEI processing order SEI message, the second syntax element indicating the preferred processing order of a second SEI message present in the bitstream, wherein the first syntax element and the second syntax element have different values, and process the first SEI message and the second SEI message in accordance with the preferred processing order. Similarly, video encoder 200 may be configured to generate an SEI processing order SEI message, encode a first syntax element in the SEI processing order SEI message, the first syntax element indicating a preferred processing order of a first SEI message present in a bitstream, and encode a second syntax element in the SEI processing order SEI message, the second syntax element indicating the preferred processing order of a second SEI message present in the bitstream, wherein the first syntax element and the second syntax element have different values.

An example SEI manifest SEI message is specified in ITU-T H.265. An SEI manifest SEI message conveys information on SEI messages that are indicated as expected (e.g., likely) to be present or not present in the encoded bitstream. An example SEI manifest SEI message syntax from H.265 is shown in Table 1.

TABLE 1
SEI manifest SEI message Syntax

| | Descriptor |
|---|---|
| sei_manifest( payloadSize ) { | |
| manifest_num_sei_msg_types | u(16) |
| for( i = 0; i < manifest_num_sei_msg_types; i++ ) { | |
| manifest_sei_payload_type[ i ] | u(16) |
| manifest_sei_description[ i ] | u(8) |
| } | |
| } | |

Semantics for the syntax elements of Table 1 are shown below.

The syntax element manifest_num_sei_msg_types specifies the number of types of SEI messages for which information is provided in the SEI manifest SEI message.

The syntax element manifest_sei_payload_type[i] indicates the payloadType value of the i-th type of SEI message for which information is provided in the SEI manifest SEI message. The values of manifest_sei_payload_type[m] and manifest_sei_payload_type[n] shall not be identical when m is not equal to n.

The syntax element manifest_sei_description[i] provides information on SEI messages with payloadType equal to manifest_sei_payload_type[i] as specified in Table 2.

TABLE 2
Interpretation of manifest_sei_description[ i ]

| Value | Description |
|---|---|
| 0 | Indicates that there is no SEI message with |
| | payloadType equal to |
| | manifest_sei_payload_type[ i ] expected to be |
| | present in the CVS. |
| 1 | Indicates that there are SEI messages with |
| | payloadType equal to |
| | manifest_sei_payload_type[ i ] expected to be |
| | present in the CVS, and these SEI messages are |
| | considered as necessary. |
| 2 | Indicates that there are SEI messages with |
| | payloadType equal to |
| | manifest_sei_payload_type[ i ] expected to be |
| | present in the CVS, and these SEI messages are |
| | considered as unnecessary. |
| 3 | Indicates that there are SEI messages with |
| | payloadType equal to |
| | manifest_sei_payload_type[ i ] expected to be |
| | present in the CVS, and the necessity of these SEI |
| | messages is undetermined. |
| 4 . . . 255 | Reserved |

In Table 2 above, CVS stands for coded video sequence. The descriptor u(8) indicates the syntax element unsigned integer coding with 8 bits. The descriptor u(160 indicates the syntax element is coded with unsigned integer coding with 16 bits.

Sean McCarthy, et al, “SEI processing order SEI message in VVC (Draft 1),” Joint Video Experts Team (JVET) of ITU-T SG 16 WP 3 and ISO/IEC JTC 1/SC 29, 27th Meeting, by teleconference, 13-22 Jul. 2022 (hereinafter, “JVET-AA2027”) describe a specification of the syntax and semantics for an SEI processing order SEI message in the VVC standard (Rec. ITU-T H.266|ISO/IEC 23090-3). The SEI processing order SEI message indicates a preferrable processing order for different types of SEI messages that may be present in the bitstream.

An example of the SEI processing order SEI message syntax is shown below.

| | Descriptor |
|---|---|
| sei_processing_order( payloadSize ) { | |
| for( i = 0, b = 0; b < payloadSize; i++, b += 3 ) { | |
| po_sei_payload_type[ i ] | u(16) |
| po_sei_processing_order[ i ] | u(8) |
| } | |
| } | |

The syntax element, po_sei_processing_order[i], indicates the preferred processing order of i-th SEI message payloadType equal to po_sei_payload_type[i].

The syntax element po_sei_processing_order[m] greater than 0 and equal to po_sei_processing_order[n] indicates that the preferred order of processing m-th and n-th payloadType is unknown or unspecified or determined by external means not specified in this Specification.

The syntax element po_sei_processing_order[i] equal to 0 specifies that the preferred order of processing i-th payloadType is unknown or unspecified or determined by external means not specified in this Specification.

Testing, as described in Peng Yin, et al, “AHG9: SEI processing order SEI message,” Joint Video Experts Team (WET) of ITU-T SG 16 WP 3 and ISO/IEC JTC 1/SC 29, 27th Meeting, by teleconference, 13-22 Jul. 2022 (hereinafter, “JVET-AA0102”), has shown that the order of processing information carried in SEI messages can be important to better ensure acceptable video system performance or user experience for use cases that include a neural-network post filter, a film grain synthesis process, or other types of post filter processes. Such post-filter processes are preferably performed in the preferred order as specified by the encoder (e.g., video encoder 200), because swapping the order at the decoder side (e.g., video decoder 300) may result in sub-optimal results. Prior SEI manifest SEI messages list the SEI messages present in the bitstream, but do not indicate the preferred processing order. This disclosure enhances the SEI manifest SEI message to indicate the preferred processing order.

As described above, JVET-AA2027 specifies one example of preferred processing order explicitly. However, such explicit indication of the preferred processing order may not be necessary and may introduce additional parsing and sorting complexity. It may also not be necessary to signal an unknown or unspecified processing order, or have the order be determined by external means. In addition, the syntax element, po_sei_payload_type[i], uses 16-bits, while the syntax element po_sei_processing_order[I] uses 8-bits. In the case where the value of the syntax element payloadType exceeds 255, the po_sei_processing_order syntax element cannot indicate the processing order of each payloadType in the worst case.

Manifest SEI Payload Type

In general, video encoder 200 and video decoder 300 may be configured to process a syntax element in an SEI manifest SEI message that indicates the preferred processing order of SEI message present in the bitstream. In a specific example, video encoder 200 and video decoder 300 may be configured to process a manifest SEI payload type syntax elements (e.g., manifest_sei_payload_type) with the following updated semantics. In general the manifest SEI payload type syntax element indicates a type of payload for the ith type of an SEI message. As shown below, the semantics of manifest_sei_payload_type is defined such that the order of manifest_sei_payload_type received indicates the preferred order of processing SEI messages with the associated type. The enhancement of the semantics of syntax element, manifest_sei_payload_type is shown between the <ADD> and </ADD> tags below:
manifest_sei_payload_type[i] indicates the payloadType value of the i-th type of SEI message for which information is provided in the SEI manifest SEI message. The values of manifest_sei_payload_type[m] and manifest_sei_payload_type[n] shall not be identical when m is not equal to n. <ADD> The order of manifest_sei_payload_type[i] indicates the preferred order of processing any SEI message with the associated manifest_sei_payload_type[i]. The SEI messages with payloadType equal to manifest_sei_payload_type[j] where j is less than i shall be processed prior to the processing of SEI message with payloadType equal to manifest_sei_payload_type[i]. </ADD>

That is, according to the techniques of this disclosure, video decoder 300 may be configured to parse and decode the manifest_sei_payload_type[i], where the order of manifest_sei_payload_type[i] indicates the preferred order of processing any SEI message with the associated manifest_sei_payload_type[i]. The SEI messages with payloadType equal to manifest_sei_payload_type[j] where j is less than i shall be processed prior to the processing of SEI message with payloadType equal to manifest_sei_payload_type[i].

In another example, the order of a manifest SEI payload type syntax element (e.g., manifest_sei_payload_type[i]) with the corresponding manifest description (e.g., manifest_sei_description[i]) not equal to 0 indicates the preferred order of processing any present SEI message with payloadType equal to manifest_sei_payload_type[i]. For example, in a situation where there are two SEI messages, one with payloadType equal to manifest_sei_payload_type[i] and one with payloadType equal to manifest_sei_payload_type[j], where j is less than i and the values of manifest_sei_description[i] and manifest_sei_description[j] are not equal to 0, the SEI message with payloadType equal to manifest_sei_payload_type[j] is preferred to be processed prior to the processing of SEI message with payloadType equal to manifest_sei_payload_type[i] at video decoder 300.

In another example, the order of a manifest SEI payload type syntax element (e.g., manifest_sei_payload_type[i]) with the corresponding manifest description (e.g., manifest_sei_description[i]) equal to a specific value (e.g. 1) indicates the preferred order of processing any present SEI message with payloadType equal to manifest_sei_payload_type[i]. For example, in the situation where there are two SEI messages, one with payloadType equal to manifest_sei_payload_type[i] and one with payloadType equal to manifest_sei_payload_type[j], where j is less than i and the values of manifest_sei_description[i] and manifest_sei_description[j] are both equal to 1, the SEI message with payloadType equal to manifest_sei_payload_type[j] is preferred to be processed prior to the processing of SEI message with payloadType equal to manifest_sei_payload_type[i] at video decoder 300.

In one example of the disclosure, video decoder 300 may be configured to receive a supplemental enhancement information (SEI) manifest SEI message, decode a syntax element in the SEI manifest SEI message that indicates a preferred processing order of SEI messages indicated by the SEI manifest SEI message as being present in a bitstream, and process the SEI message present in the bitstream in accordance with the preferred processing order. In one example, the syntax element is a manifest SEI payload type syntax element. In a further example, the manifest SEI payload type syntax element is a manifest_sei_payload_type[i] syntax element.

In one example, the order of the manifest_sei_payload_type[i] syntax element indicates the preferred order of processing any SEI message with the associated manifest_sei_payload_type[i]. In a further example, to process the SEI message present in the bitstream in accordance with the preferred processing order, video decoder 300 is configured to process the SEI messages with a payloadType equal to manifest_sei_payload_type[j], where j is less than I, prior to the processing of SEI message with payloadType equal to manifest_sei_payload_type[i].

Inference of Preferred Processing Order

In another example of the disclosure, it is proposed to remove the syntax element, po_sei_processing_order[i] from the SEI message. Instead, video decoder 300 may be configured to infer the preferred processing order as being the same as the signaling order of the payloadType being signaled. That is, video encoder 200 and video decoder 300 are not configured to code a po_sei_processing_order[i] syntax element that indicates the preferred processing order of i-th SEI message payloadType equal to po_sei_payload_type[i]. Rather, video decoder 300 is configured infer the preferred processing of the of i-th SEI message payloadType to be the same as the signaling order of the payloadType being signaled.

The modified SEI message syntax, relative to the JVET-AA2027 techniques described above, is shown below. In particular, the po_sei_processing_order[i] syntax element is removed and the for loop is changed from “for (i=0, b=0; b<payloadSize; i++, b+=3)” to “for (i=0, b=0; b<payloadSize; i++, b+=2).”

| | Descriptor |
|---|---|
| sei_processing_order( payloadSize ) { | |
| for( i = 0, b = 0; b < payloadSize; i++, b += 2 ) { | |
| po_sei_payload_type[ i ] | u(16) |
| } | |
| } | |

The modified semantics, relative to the JVET-AA2027 techniques described above, is shown below. Additions are shown between the tags <ADD> and </ADD>.

D.11.2 SEI processing order SEI message semantics

The SEI processing order SEI message carries information indicating the preferred
processing order, as determined by the encoder (i.e., the content producer), for different
types of SEI messages that may be present in the bitstream. When an SEI processing
order SEI message is present in any access unit of a CVS, an SEI processing order SEI
message shall be present in the first access unit of the CVS. The SEI processing order
SEI message persists in decoding order from the current access unit until the end of the
CVS. When there are multiple SEI processing order SEI messages present in a CVS,
they shall have the same content.
po_sei_payload_type[ i ] specifies the value of payloadType for the i-th SEI message
for which information is provided in the SEI processing order SEI message. The values
of po_sei_payload_type[ m ] and po_sei_payload_type[ n ] shall not be identical when
m is not equal to n. <ADD>Any SEI message with payloadType equal to
po_sei_payload_type[ m ], when present, should be processed before any SEI message
with payloadType equal to po_sei_payload_type[ n ], when present, where m is less
than n. </ADD>

Interaction Between Payload Type and Processing Order

In another example, video encoder 200 and video decoder 300 be configured to use the same type of coding for both the payload type (e.g., po_sei_payload_type[i]) and the processing order (e.g., po_sei_processing_order[i]) syntax elements. For example, video encoder 200 and video decoder 300 be configured to use u(8) coding (unsigned integer coding using 8 bits) for both the payload type (e.g., po_sei_payload_type[i]) and the processing order (e.g., po_sei_processing_order[i]) syntax elements. Alternatively, video encoder 200 and video decoder 300 be configured to use u(16) coding (unsigned integer coding using 16 bits) for both the payload type (e.g., po_sei_payload_type[i]) and the processing order (e.g., po_sei_processing_order[i]) syntax elements. Using the same coding for both syntax elements may avoid problems with future implementations that use more payload types.

Two examples of the modified SEI processing order SEI message syntax is shown below.

Example 1 where both syntax elements use u(8) coding.

| | Descriptor |
|---|---|
| sei_processing_order( payloadSize ) { | |
| for( i = 0, b = 0; b < payloadSize; i++, b += 2 ) { | |
| po_sei_payload_type[ i ] | u(8) |
| po_sei_processing_order[ i ] | u(8) |
| } | |
| } | |

Example 2 where both syntax elements use u(16) coding.

| | Descriptor |
|---|---|
| sei_processing_order( payloadSize ) { | |
| for( i = 0, b = 0; b < payloadSize; i++, b += 4 ) { | |
| po_sei_payload_type[ i ] | u(16) |
| po_sei_processing_order[ i ] | u(16) |
| } | |
| } | |

In some situations, every processing order syntax element (e.g., po_sei_processing_order) in the SEI processing order SEI message may share the same value. This situation indicates that there is no preferred order of processing among all SEI messages associated with the SEI processing order SEI message. To address this ambiguity, this disclosure proposes that video encoder 200 and video decoder 300 operate according to a constraint that disallows such a situation. That is, video encoder 200 and video decoder 300 may be configured such that syntax elements po_sei_processing_order[i] do not have the same value. In one example, such a constraint is implemented as follows:

It is required that an SEI processing order SEI message shall contain at least two processing order syntax elements, po_sei_processing_order[i] and po_sei_processing_order[j] where i is not equal to j, that have a different value.

Accordingly, in one example of the disclosure video decoder 300 may be configured to receive an SEI processing order SEI message, decode a first syntax element in the SEI processing order SEI message, the first syntax element indicating a preferred processing order of a first SEI message present in a bitstream, decode a second syntax element in the SEI processing order SEI message, the second syntax element indicating the preferred processing order of a second SEI message present in the bitstream, wherein the first syntax element and the second syntax element have different values, and process the first SEI message and the second SEI message in accordance with the preferred processing order. Similarly, video encoder 200 may be configured to generate an SEI processing order SEI message, encode a first syntax element in the SEI processing order SEI message, the first syntax element indicating a preferred processing order of a first SEI message present in a bitstream, and encode a second syntax element in the SEI processing order SEI message, the second syntax element indicating the preferred processing order of a second SEI message present in the bitstream, wherein the first syntax element and the second syntax element have different values.

The first syntax element and the second syntax element may be a po_sei_processing_order[i] syntax element, wherein a value of i indicates a particular SEI message. Video encoder 200 and video decoder 300 may further be configured to code an SEI payload type syntax element, wherein the SEI payload type syntax element using a first coding technique. Video encoder 200 and video decoder 300 may also code the first syntax element using the first coding technique. The first coding technique may an 8-bit unsigned integer (u(8)) coding technique or a 16-bit unsigned integer (u(16)) coding technique.

T35 SEI Messages

When an SEI payload type in the SEI processing order SEI message is the user data registered by a T35 SEI message, there may be multiple T35 SEI messages presented in the bitstream. Each T35 message may have a different country code, provider code, application identifier, and/or application mode. In general, a T35 message defines the format and allocation of country codes and other signaling information for international telecommunications networks. The T35 message may provide a standardized way to identify and control various aspects of telecommunications services across different countries and regions.

In another example of the disclosure, video encoder 200 and video decoder 300 may be configured encode and decode these T35 codes (e.g., the country code, provider code, application identifier, and/or application mode) in the SEI processing order SEI message to identify the specific T35 SEI message and associated processing order. An example syntax structure is shown below.

| | Descriptor |
|---|---|
| sei_processing_order( payloadSize ) { | |
| po_num_sei_msg_types_minus2 | u(16) |
| for( i = 0; i < (po_num_sei_msg_types + 2 ); i++ ) { | |
| po_sei_payload_type[ i ] | u(16) |
| if ( po_sei_payload_type[ i ] == 4 ) { | |
| po_t35_country_code[ i ] | u(8) |
| if ( po_t35_country_code == 0xFF ) | |
| po_t35_country_code_extension_byte | u(8) |
| po_num_t35_payload_bytes[ i ] | ue(v) |
| for ( j = 0; j < po_num_t35_payload_bytes[ i ]; | |
| j ++ ) { | |
| po_t35_code[ i ] [ j ] | u(8) |
| } | |
| } | |
| po_sei_processing_order[ i ] | u(16) |
| } | |
| } | |

po_t35_country_code[i] is the itu_t_t35_country_code of the i-th SEI message

po_t35_country_code_extension_byte[i] is the itu_t_t35_country_code_extension_byte of the i-th SEI message

po_num_t35_payload_bytes[i] specifies the number of po_t35_code associated with the i-th SEI message presented in the SEI processing order SEI message.

po_t35_code[i] [j] is the j-th itu_t_t35_payload_byte of i-th SEI message

In another example, when an SEI message of the SEI processing order SEI message is a T35 SEI message, the first N bytes of the associated T35 SEI message may be indicated in the SEI processing order SEI message for the identification.

In general, video encoder 200 and/or video decoder 300 may be configured to code a syntax element indicating a first N bytes of an SEI message. In one example, the SEI message is a T35 SEI message, wherein the T35 SEI message indicates at least a country code.

An example syntax structure is shown below.

| | Descriptor |
|---|---|
| sei_processing_order( payloadSize ) { | |
| po_num_sei_msg_types_minus2 | u(16) |
| for( i = 0; i < (po_num_sei_msg_types + 2 ); i++ ) { | |
| po_sei_payload_type[ i ] | u(16) |
| if ( po_sei_payload_type[ i ] == 4 ) { | |
| po_num_t35_bytes[ i ] | ue(v) |
| for ( j = 0; j < po_num_t35_ bytes[ i ]; j ++ ) { | |
| po_t35_byte[ i ] [ j ] | u(8) |
| } | |
| } | |
| po_sei_processing_order[ i ] | u(16) |
| } | |
| } | |

po_num_t35_ bytes[i] specifies the number of bytes associated with the i-th SEI message presented in the SEI processing order SEI message.

po_t35_byte[i] [j] is the j-th byte value of i-th SEI message.

In another example, it is proposed that SEI processing order SEI message shall not indicate the processing order of the user data registered by T35 SEI message.

When an SEI payload type in the SEI processing order SEI message is the user data unregistered SEI message, there may be multiple user data unregistered SEI messages in the bitstream. Each data unregistered SEI message may have a different uuid_iso_iec_11578 value. In another example of the disclosure, video encoder 200 and video decoder 300 may be configured encode and decode the data unregistered SEI message to indicate the uuid_iso_iec_11578 of the corresponding user data unregistered SEI message in the SEI processing order SEI message for the identification. An example syntax structure is shown below.

| | Descriptor |
|---|---|
| sei_processing_order( payloadSize ) { | |
| po_num_sei_msg_types_minus2 | |
| for( i = 0; i < (po_num_sei_msg_types + 2); i++ ) { | |
| po_sei_payload_type[ i ] | u(16) |
| if ( po_sei_payload_type[ i ] == 5 ) | |
| po_uuid_iso_iec_11578[ i ] | u(128) |
| po_sei_processing_order[ i ] | u(16) |
| } | |
| } | |

po_uuid_iso_iec_11578 is the uuid_iso_iec_11578 of the i-th SEI message.

Prefix Information

In another example, the SEI processing order SEI message may be further enhanced for any type of SEI messages where the prefix information, such as the first N bytes or bits of an SEI message, are present to identify the purpose of SEI message in cases when several messages of the same type, but with different purpose, are present and their order of processing may be relevant.

One syntax structure example of SEI processing order SEI message is shown below.

| | Descriptor |
|---|---|
| sei_processing_order( payloadSize ) { | |
| po_num_sei_msg_types_minus2 | u(16) |
| po_prefix_bit_present_flag | u(1) |
| for( i = 0; i < (po_num_sei_msg_types_minus2 + | |
| 2); i++ ) { | |
| po_sei_payload_type[ i ] | u(16) |
| if(po_prefix_bit_present_flag) { | |
| po_num_prefix_bit[ i ] | ue(v) |
| for( j = 0; j < po_num_prefix_bit[ i ]; j++ ) | |
| { | |
| po_prefix_bit[ i ][ j ] | b(1) |
| } | |
| } | |
| po_sei_processing_order[ i ] | u(16) |
| } | |
| } | |

po_prefix_bit_present_flag equal to 1 indicate the prefix bits of an SEI message may be present in the SEI processing order SIE message.

po_num_prefix_bit specifies the number of prefix bit of the i-th SEI message to present

po_prefix_bit specifies the value of j-th prefix bit of i-th SEI message

In this example, video encoder 200 and video decoder 300 may be configured to code a prefix present flag (e.g., po_prefix_bit_present_flag) wherein the prefix present flag indicates if a prefix syntax element (e.g., po_num_prefix_bit and/or po_prefix_bit) is present in the SEI processing order SEI message. The prefix syntax element may indicate prefix bits or prefix bytes for and SEI message. Video encoder 200 and video decoder may code the prefix syntax element based on the prefix present flag.

For example, when the prefix syntax element indicates a value of a prefix bit for an SEI message, video encoder 200 and video decoder 300 may code a number of prefix bits syntax element that indicates a number of prefix syntax elements that are present in the SEI processing order SEI message. When the prefix syntax element indicates a value of a prefix byte for an first SEI message, video encoder 200 and video decoder 300 may code a number of prefix bytes syntax element that indicates a number of prefix syntax elements that are present in the SEI processing order SEI message.

Another syntax structure example of SEI processing order SEI message is shown below.

| | Descriptor |
|---|---|
| sei_processing_order( payloadSize ) { | |
| po_num_sei_msg_types | u(16) |
| for( i = 0; i < po_num_sei_msg_types; i++ ) { | |
| po_sei_payload_type[ i ] | u(16) |
| po_sei_processing_order[ i ] | u(16) |
| } | |
| po_num_sei_msg_types_w_prefix | u(16) |
| for( i = 0; i < po_num_sei_msg_types_w_prefix; | |
| i++ ) { | |
| po_sei_payload_type[ i ] | u(16) |
| po_num_prefix_bit[ i ] | ue(v) |
| for( j = 0; j < po_num_prefix_bit[ i ]; j++ ) { | |
| po_prefix_bit[ i ][ j ] | b(1) |
| } | |
| po_sei_processing_order[ i ] | u(16) |
| } | |
| } | |

po_num_sei_msg_types specifies the number of SEI message types without prefix information present.

po_num_sei_msg_types_w_prefix indicates the number of SEI message types with associated prefix information present.

Additional syntax element may be signaled to indicate the bit or byte offset of the location of prefix bits or bytes of SEI message.

The following constraint is proposed to ensure the same SEI message does not have different processing value within a CVS.

The SEI message with the same payloadType, and the same prefix SEI message bits when present, shall have the same SEI processing order value.

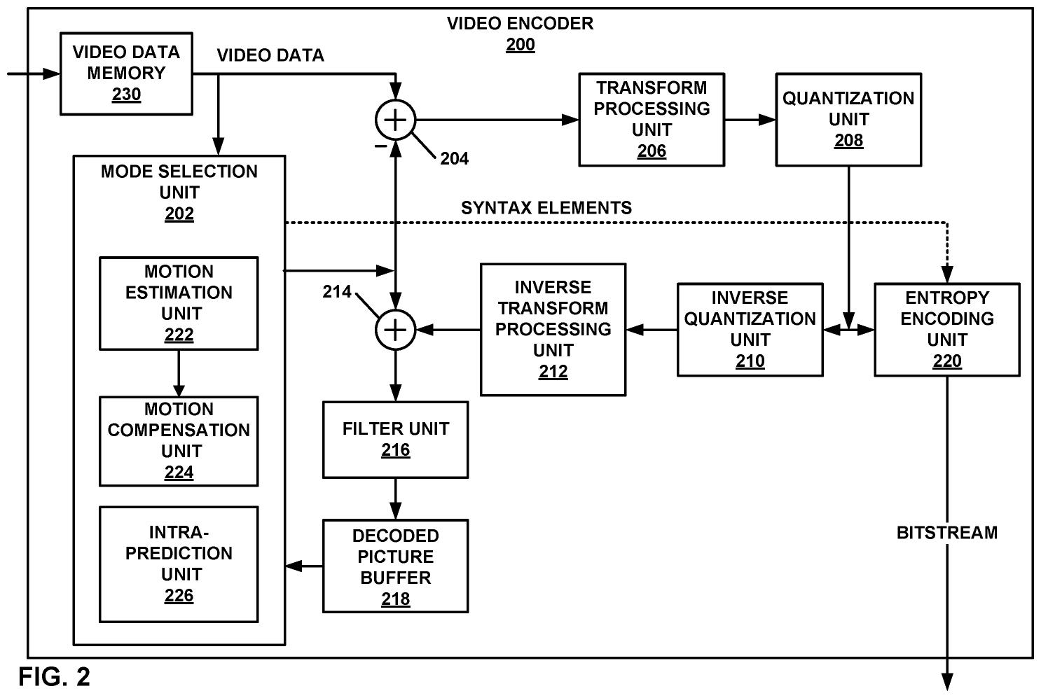

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to generate an SEI processing order SEI message, encode a first syntax element in the SEI processing order SEI message, the first syntax element indicating a preferred processing order of a first SEI message present in a bitstream, and encode a second syntax element in the SEI processing order SEI message, the second syntax element indicating the preferred processing order of a second SEI message present in the bitstream, wherein the first syntax element and the second syntax element have different values.

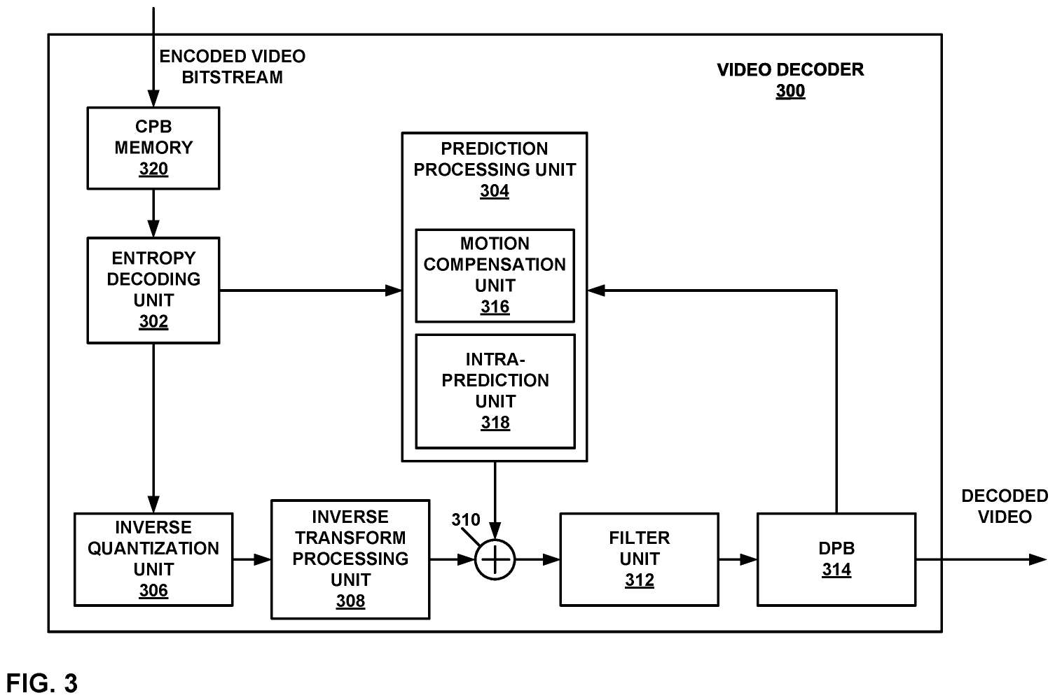

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to receive an SEI processing order SEI message, decode a first syntax element in the SEI processing order SEI message, the first syntax element indicating a preferred processing order of a first SEI message present in a bitstream, decode a second syntax element in the SEI processing order SEI message, the second syntax element indicating the preferred processing order of a second SEI message present in the bitstream, wherein the first syntax element and the second syntax element have different values, and process the first SEI message and the second SEI message in accordance with the preferred processing order.

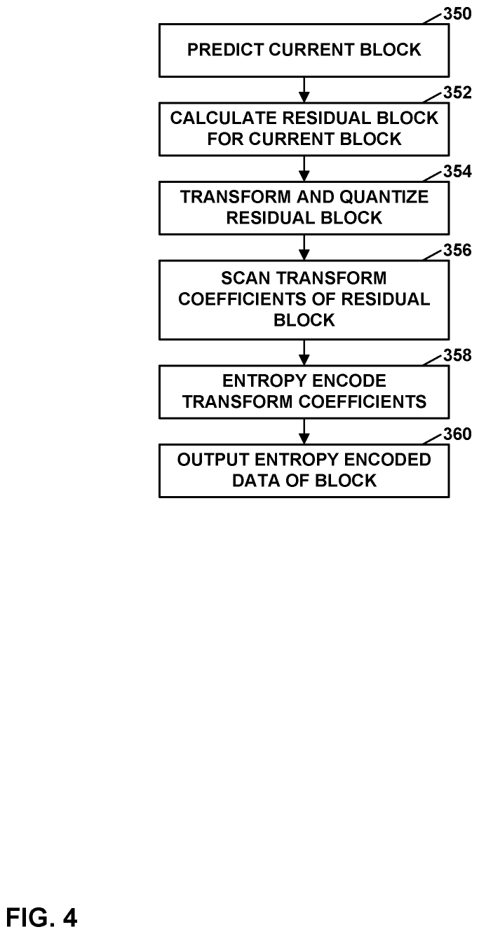

FIG. 4 is a flowchart illustrating an example method for encoding a current block in accordance with the techniques of this disclosure. The current block may comprise a current CU. Although described with respect to video encoder 200 (FIGS. 1 and 2), it should be understood that other devices may be configured to perform a method similar to that of FIG. 4.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

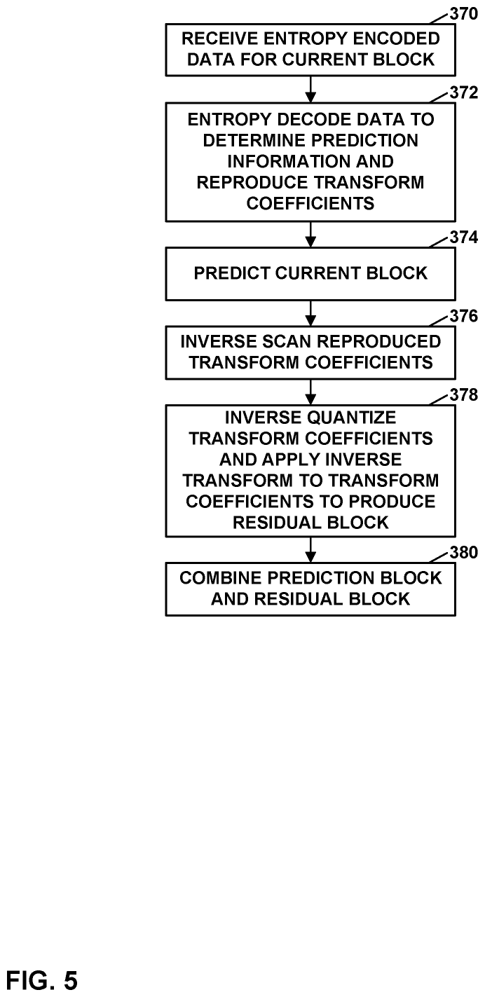

FIG. 5 is a flowchart illustrating an example method for decoding a current block of video data in accordance with the techniques of this disclosure. The current block may comprise a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

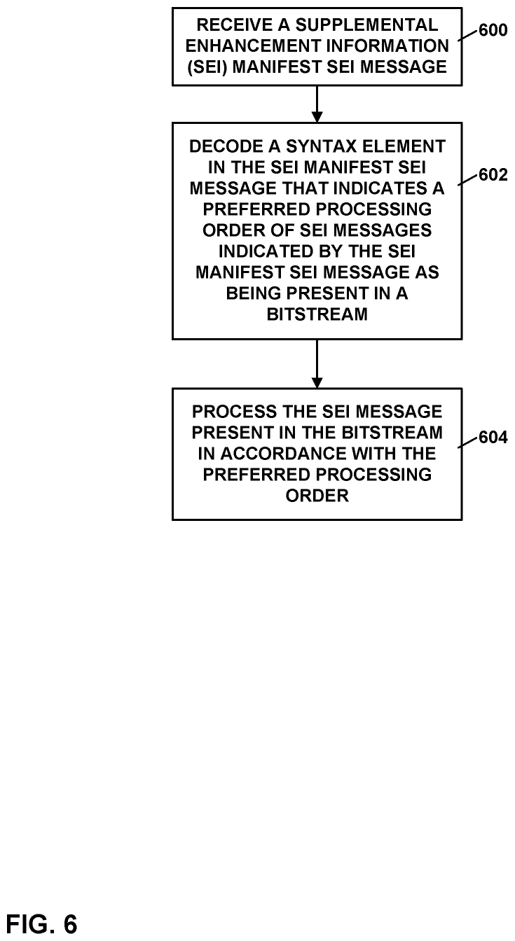

FIG. 6 is a flowchart illustrating an example method for processing an SEI manifest SEI message in accordance with the techniques of this disclosure. Video decoder 300 may be configured to receive a supplemental enhancement information (SEI) manifest SEI message (600), decode a syntax element in the SEI manifest SEI message that indicates a preferred processing order of SEI messages indicated by the SEI manifest SEI message as being present in a bitstream (602), and process the SEI message present in the bitstream in accordance with the preferred processing order (604).

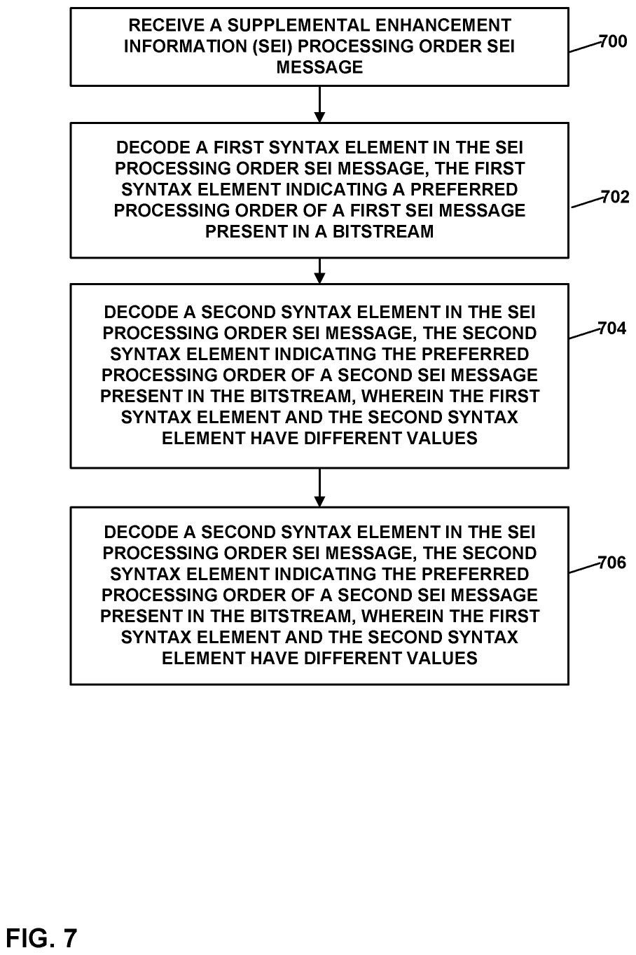

FIG. 7 is a flowchart illustrating an example method for decoding an SEI processing order SEI message in accordance with the techniques of this disclosure. The techniques of FIG. 7 may be performed by one or more structural components of video decoder 300.

In one example, video decoder 300 is configured to receive a supplemental enhancement information (SEI) processing order SEI message (700). Video decoder 300 may decode a first syntax element in the SEI processing order SEI message, the first syntax element indicating a preferred processing order of a first SEI message present in a bitstream (702), and decode a second syntax element in the SEI processing order SEI message, the second syntax element indicating the preferred processing order of a second SEI message present in the bitstream, wherein the first syntax element and the second syntax element have different values (704). Video decoder 300 may then process the first SEI message and the second SEI message in accordance with the preferred processing order. In one example, the first syntax element and the second syntax element is a po_sei_processing_order[i] syntax element, wherein a value of i indicates a particular SEI message.

In a further example of the disclosure, video decoder 300 may be configured to decode an SEI payload type syntax element using a first decoding technique. Video decoder 300 is also configured to decode the first syntax element described above using the first decoding technique. In one example, the first decoding technique is an 8-bit unsigned integer (u(8)) decoding technique. In another example, the first decoding technique is a 16-bit unsigned integer (u(16)) decoding technique.

In a further example of the disclosure, video decoder 300 may be configured to decode a third syntax element indicating a first N bytes of the first SEI message. In one example, the first SEI message is a T35 SEI message, wherein the T35 SEI message indicates at least a country code.

In a further example of the disclosure, video decoder 300 may be configured to decode a prefix present flag, wherein the prefix present flag indicates if a prefix syntax element is present in the SEI processing order SEI message, the prefix syntax element indicating prefix bits or prefix bytes for the first SEI message, and decode the prefix syntax element based on the prefix present flag. In one example, the prefix syntax element indicates a value of a prefix bit for the first SEI message, and video decoder 300 is further configured to decode a number of prefix bits syntax element that indicates a number of prefix syntax elements that are present in the SEI processing order SEI message. In another example, the prefix syntax element indicates a value of a prefix byte for the first SEI message, and video decoder 300 is further configured to decode a number of prefix bytes syntax element that indicates a number of prefix syntax elements that are present in the SEI processing order SEI message.

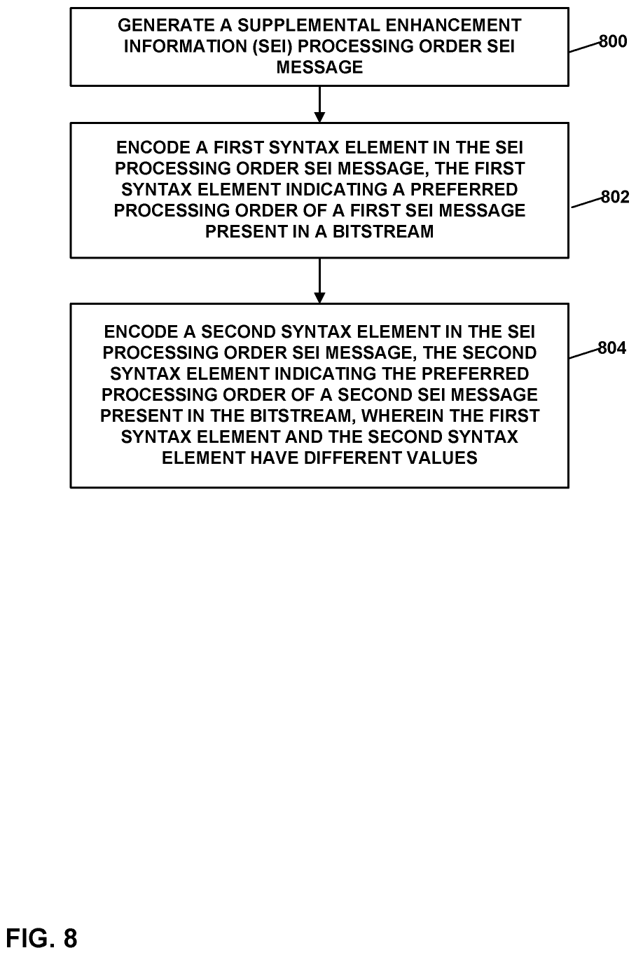

FIG. 8 is a flowchart illustrating an example method for encoding an SEI processing order SEI message in accordance with the techniques of this disclosure. The techniques of FIG. 8 may be performed by one or more structural components of video encoder 200.

In one example, video encode 200 is configured to generate a supplemental enhancement information (SEI) processing order SEI message (800). Video encoder 200 may further encode a first syntax element in the SEI processing order SEI message, the first syntax element indicating a preferred processing order of a first SEI message present in a bitstream (802), and encode a second syntax element in the SEI processing order SEI message, the second syntax element indicating the preferred processing order of a second SEI message present in the bitstream, wherein the first syntax element and the second syntax element have different values (804).

In another example of the disclosure, video encoder 200 is further configured to encode an SEI payload type syntax using a first encoding technique, and is further configured to encode the first syntax element described above using the first encode technique. In one example, the first encoding technique is a 16-bit unsigned integer (u(16)) encoding technique. In another example, the first encoding technique is an 8-bit unsigned integer (u(8)) encoding technique.

In another example, video encoder 200 may be configured to encode a third syntax element indicating a first N bytes of the first SEI message. In one example, the first SEI message is a T35 SEI message, wherein the T35 SEI message indicates at least a country code.

In another example, video encoder 200 may be configured to encode a prefix present flag, wherein the prefix present flag indicates if a prefix syntax element is present in the SEI processing order SEI message, the prefix syntax element indicating prefix bits or prefix bytes for the first SEI message. Video encoder 200 may encode the prefix syntax element based on the prefix present flag.

Illustrative aspects of the disclosure are described below.

Aspect 1A—A method of processing video data, the method comprising: receiving a supplemental enhancement information (SEI) manifest SEI message; decoding a syntax element in the SEI manifest SEI message that indicates a preferred processing order of SEI messages indicated by the SEI manifest SEI message as being present in a bitstream; and processing the SEI message present in the bitstream in accordance with the preferred processing order.

Aspect 2A—The method of Aspect 1A, wherein the syntax element is a manifest SEI payload type syntax element.

Aspect 3A—The method of Aspect 2A, wherein the manifest SEI payload type syntax element is a manifest_sei_payload_type[i] syntax element.

Aspect 4A—The method of Aspect 3A, wherein the order of the manifest_sei_payload_type[i] syntax element indicates the preferred order of processing any SEI message with the associated manifest_sei_payload_type[i].

Aspect 5A—The method of Aspect 4A, wherein processing the SEI message present in the bitstream in accordance with the preferred processing order comprises: processing the SEI messages with a payloadType equal to manifest_sei_payload_type[j], where j is less than I, prior to the processing of SEI message with payloadType equal to manifest_sei_payload_type[i].

Aspect 6A—A device for coding video data, the device comprising one or more means for performing the method of any of Aspects 1A-5A and 13A-17A.

Aspect 7A—The device of Aspect 6A, wherein the one or more means comprise one or more processors implemented in circuitry.

Aspect 8A—The device of any of Aspects 6A and 7A, further comprising a memory to store the video data.

Aspect 9A—The device of any of Aspects 6A-8A, further comprising a display configured to display decoded video data.

Aspect 10A—The device of any of Aspects 6A-9A, wherein the device comprises one or more of a camera, a computer, a mobile device, a broadcast receiver device, or a set-top box.

Aspect 11A—The device of any of Aspects 6A-10A, wherein the device comprises a video decoder.

Aspect 12A—A computer-readable storage medium having stored thereon instructions that, when executed, cause one or more processors to perform the method of any of Aspects 1A-5A.

Aspect 13A—The method of Aspect 1A, wherein the syntax element comprises an array of SEI message payload type values, wherein an order of the SEI message payload type values in the array corresponds to the preferred processing order of SEI messages in the bitstream.

Aspect 14A—The method of any of Aspects 1A-5A or 13A, wherein the preferred processing order indicates that a first SEI message payload type is to be processed before a second SEI message payload type, the method further comprising: receiving a second SEI message having the second SEI message payload type in the bitstream; after receiving the second SEI message, receiving a first SEI having the first SEI message payload type in the bitstream; and processing the first SEI message before the second SEI message according to the preferred processing order

Aspect 15A—A method of processing video data, the method comprising: receiving a supplemental enhancement information (SEI) processing order SEI message; inferring a preferred processing order of SEI messages indicated by the SEI processing order SEI message as being present in a bitstream based on a signaling order of a payload type; and processing the SEI messages present in the bitstream in accordance with the preferred processing order.

Aspect 16A—The method of Aspect 15A, further comprising: coding two or more syntax elements in the SEI processing order SEI message using unsigned integer coding with 8 bits.

Aspect 17A—The method of claim 15A, further comprising: coding two or more syntax elements in the SEI processing order SEI message using unsigned integer coding with 16 bits.

Aspect 18A—The method of claim 15A, further comprising: coding at least two po_sei_processing_order syntax elements in the SEI processing order SEI message, wherein the two po_sei_processing_order syntax elements have different values.

Aspect 19A—The method of claim 15A, further comprising: coding an SEI payload type in the SEI processing order SEI message, wherein the SEI payload type is user data registered by a T35 SEI message; and coding, based on the SEI payload type being the user data registered by the T35 SEI message, one or more of a country code, provider code, application identifier, or application mode for the T35 SEI message in the SEI processing order SEI message.

Aspect 20A—The method of claim 15A, further comprising: coding a syntax element that indicates a first N bytes of a T35 SEI message.

Aspect 21A—The method of claim 15A, further comprising: coding an SEI payload type in the SEI processing order SEI message, wherein the SEI payload type is a user data registered SEI message; and coding, based on the SEI payload type being the user data registered SEI message, a syntax element that indicates a uuid_iso_iec_11578 value.

Aspect 1B—A method of processing video data, the method comprising: receiving a supplemental enhancement information (SEI) processing order SEI message; decoding a first syntax element in the SEI processing order SEI message, the first syntax element indicating a preferred processing order of a first SEI message present in a bitstream; decoding a second syntax element in the SEI processing order SEI message, the second syntax element indicating the preferred processing order of a second SEI message present in the bitstream, wherein the first syntax element and the second syntax element have different values; and processing the first SEI message and the second SEI message in accordance with the preferred processing order.

Aspect 2B—The method of Aspect 1B, wherein the first syntax element and the second syntax element is a po_sei_processing_order[i] syntax element, wherein a value of i indicates a particular SEI message.

Aspect 3B—The method of any of Aspects 1B-2B, further comprising: decoding an SEI payload type syntax element using a first decoding technique, and wherein decoding the first syntax element comprises decoding the first syntax element using the first decoding technique.

Aspect 4B—The method of Aspect 3B, wherein the first decoding technique is an 8-bit unsigned integer (u(8)) decoding technique.

Aspect 5B—The method of Aspect 3B, wherein the first decoding technique is a 16-bit unsigned integer (u(16)) decoding technique.

Aspect 6B—The method of any of Aspects 1B-5B, further comprising: decoding a third syntax element indicating a first N bytes of the first SEI message.

Aspect 7B—The method of Aspect 6B, wherein the first SEI message is a T35 SEI message, wherein the T35 SEI message indicates at least a country code.

Aspect 8B—The method of any of Aspects 1B-7B, further comprising: decoding a prefix present flag, wherein the prefix present flag indicates if a prefix syntax element is present in the SEI processing order SEI message, the prefix syntax element indicating prefix bits or prefix bytes for the first SEI message; and decoding the prefix syntax element based on the prefix present flag.

Aspect 9B—The method of Aspect 8B, wherein the prefix syntax element indicates a value of a prefix bit for the first SEI message, the method further comprising: decoding a number of prefix bits syntax element that indicates a number of prefix syntax elements that are present in the SEI processing order SEI message.

Aspect 10B—The method of Aspect 8B, wherein the prefix syntax element indicates a value of a prefix byte for the first SEI message, the method further comprising: decoding a number of prefix bytes syntax element that indicates a number of prefix syntax elements that are present in the SEI processing order SEI message.

Aspect 11B—An apparatus configured to process video data, the apparatus comprising: a memory configured to store the video data; and one or more processors coupled to the memory, wherein the apparatus is configured to: receive a supplemental enhancement information (SEI) processing order SEI message; decode a first syntax element in the SEI processing order SEI message, the first syntax element indicating a preferred processing order of a first SEI message present in a bitstream; decode a second syntax element in the SEI processing order SEI message, the second syntax element indicating the preferred processing order of a second SEI message present in the bitstream, wherein the first syntax element and the second syntax element have different values; and process the first SEI message and the second SEI message in accordance with the preferred processing order.

Aspect 12B—The apparatus of Aspect 11B, wherein the first syntax element and the second syntax element is a po_sei_processing_order[i] syntax element, wherein a value of i indicates a particular SEI message.

Aspect 13B—The apparatus of any of Aspects 11B-12B, wherein the apparatus is further configured to: decode an SEI payload type syntax element using a first decoding technique, and wherein to decode the first syntax element, the apparatus is configured to decode the first syntax element using the first decoding technique.

Aspect 14B—The apparatus of Aspect 13B, wherein the first decoding technique is an 8-bit unsigned integer (u(8)) decoding technique.

Aspect 15B—The apparatus of Aspect 13B, wherein the first decoding technique is a 16-bit unsigned integer (u(16)) decoding technique.

Aspect 16B—The apparatus of any of Aspects 11B-15B, wherein the apparatus is further configured to: decode a third syntax element indicating a first N bytes of the first SEI message.

Aspect 17B—The apparatus of Aspect 16B, wherein the first SEI message is a T35 SEI message, wherein the T35 SEI message indicates at least a country code.

Aspect 18B—The apparatus of any of Aspects 11B-17B, wherein the apparatus is further configured to: decode a prefix present flag, wherein the prefix present flag indicates if a prefix syntax element is present in the SEI processing order SEI message, the prefix syntax element indicating prefix bits or prefix bytes for the first SEI message; and decode the prefix syntax element based on the prefix present flag.

Aspect 19B—The apparatus of Aspect 18B, wherein the prefix syntax element indicates a value of a prefix bit for the first SEI message, and wherein the apparatus is further configured to: decode a number of prefix bits syntax element that indicates a number of prefix syntax elements that are present in the SEI processing order SEI message.

Aspect 20B—The apparatus of Aspect 18B, wherein the prefix syntax element indicates a value of a prefix byte for the first SEI message, and wherein the apparatus is further configured to: decode a number of prefix bytes syntax element that indicates a number of prefix syntax elements that are present in the SEI processing order SEI message.

Aspect 21B—A method of processing video data, the method comprising: generating a supplemental enhancement information (SEI) processing order SEI message; encoding a first syntax element in the SEI processing order SEI message, the first syntax element indicating a preferred processing order of a first SEI message present in a bitstream; and encoding a second syntax element in the SEI processing order SEI message, the second syntax element indicating the preferred processing order of a second SEI message present in the bitstream, wherein the first syntax element and the second syntax element have different values.

Aspect 22B—The method of Aspect 21B, further comprising: encoding an SEI payload type syntax element using a first encoding technique, and wherein encoding the first syntax element comprises encoding the first syntax element using the first encoding technique.

Aspect 23B—The method of Aspect 22B, wherein the first encoding technique is a 16-bit unsigned integer (u(16)) encoding technique.

Aspect 24B—The method of any of Aspects 21B-23B, further comprising:
encoding a third syntax element indicating a first N bytes of the first SEI message.

Aspect 25B—The method of any of Aspects 21B-24B, further comprising:
encoding a prefix present flag, wherein the prefix present flag indicates if a prefix syntax element is present in the SEI processing order SEI message, the prefix syntax element indicating prefix bits or prefix bytes for the first SEI message; and encoding the prefix syntax element based on the prefix present flag.

Aspect 26B—An apparatus configured to process video data, the apparatus comprising: a memory configured to store the video data; and one or more processors coupled to the memory, wherein the apparatus is configured to: generate a supplemental enhancement information (SEI) processing order SEI message; encode a first syntax element in the SEI processing order SEI message, the first syntax element indicating a preferred processing order of a first SEI message present in a bitstream; and encode a second syntax element in the SEI processing order SEI message, the second syntax element indicating the preferred processing order of a second SEI message present in the bitstream, wherein the first syntax element and the second syntax element have different values.

Aspect 27B—The apparatus of Aspect 26B, wherein the apparatus is further configured to: encode an SEI payload type syntax element using a first encoding technique, and wherein to encode the first syntax element, the apparatus is configured to encode the first syntax element using the first encoding technique.

Aspect 28B—The apparatus of Aspect 27B, wherein the first encoding technique is a 16-bit unsigned integer (u(16)) encoding technique.

Aspect 29B—The apparatus of any of Aspects 26B-28B, wherein the apparatus is further configured to: encode a third syntax element indicating a first N bytes of the first SEI message.

Aspect 30B—The apparatus of any of Aspects 26B-29B, wherein the apparatus is further configured to: encode a prefix present flag, wherein the prefix present flag indicates if a prefix syntax element is present in the SEI processing order SEI message, the prefix syntax element indicating prefix bits or prefix bytes for the first SEI message; and encode the prefix syntax element based on the prefix present flag.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
receiving a supplemental enhancement information (SEI) processing order SEI message;
decoding a first syntax element in the SEI processing order SEI message, the first syntax element indicating a preferred processing order of a first SEI message present in a bitstream;
decoding a second syntax element in the SEI processing order SEI message, the second syntax element indicating the preferred processing order of a second SEI message present in the bitstream, wherein the first syntax element and the second syntax element have different values; and
processing the first SEI message and the second SEI message in accordance with the preferred processing order.

2. The method of claim 1, wherein the first syntax element and the second syntax element is a po_sei_processing_order[i] syntax element, wherein a value of i indicates a particular SEI message.

3. The method of claim 1, further comprising:
decoding an SEI payload type syntax element using a first decoding technique, and
wherein decoding the first syntax element comprises decoding the first syntax element using the first decoding technique.

4. The method of claim 3, wherein the first decoding technique is an 8-bit unsigned integer (u(8)) decoding technique.

5. The method of claim 3, wherein the first decoding technique is a 16-bit unsigned integer (u(16)) decoding technique.

6. The method of claim 1, further comprising:
decoding a third syntax element indicating a first N bytes of the first SEI message.

7. The method of claim 6, wherein the first SEI message is a T35 SEI message, wherein the T35 SEI message indicates at least a country code.

8. The method of claim 1, further comprising:
decoding a prefix present flag, wherein the prefix present flag indicates if a prefix syntax element is present in the SEI processing order SEI message, the prefix syntax element indicating prefix bits or prefix bytes for the first SEI message; and
decoding the prefix syntax element based on the prefix present flag.

9. The method of claim 8, wherein the prefix syntax element indicates a value of a prefix bit for the first SEI message, the method further comprising:
decoding a number of prefix bits syntax element that indicates a number of prefix syntax elements that are present in the SEI processing order SEI message.

10. The method of claim 8, wherein the prefix syntax element indicates a value of a prefix byte for the first SEI message, the method further comprising:
decoding a number of prefix bytes syntax element that indicates a number of prefix syntax elements that are present in the SEI processing order SEI message.

11. An apparatus configured to process video data, the apparatus comprising:
a memory configured to store the video data; and
one or more processors coupled to the memory, wherein the apparatus is configured to:
receive a supplemental enhancement information (SEI) processing order SEI message;
decode a first syntax element in the SEI processing order SEI message, the first syntax element indicating a preferred processing order of a first SEI message present in a bitstream;
decode a second syntax element in the SEI processing order SEI message, the second syntax element indicating the preferred processing order of a second SEI message present in the bitstream, wherein the first syntax element and the second syntax element have different values; and
process the first SEI message and the second SEI message in accordance with the preferred processing order.

12. The apparatus of claim 11, wherein the first syntax element and the second syntax element is a po_sei_processing_order[i] syntax element, wherein a value of i indicates a particular SEI message.

13. The apparatus of claim 11, wherein the apparatus is further configured to:
decode an SEI payload type syntax element using a first decoding technique, and
wherein to decode the first syntax element, the apparatus is configured to decode the first syntax element using the first decoding technique.

14. The apparatus of claim 13, wherein the first decoding technique is an 8-bit unsigned integer (u(8)) decoding technique.

15. The apparatus of claim 13, wherein the first decoding technique is a 16-bit unsigned integer (u(16)) decoding technique.

16. The apparatus of claim 11, wherein the apparatus is further configured to:
decode a third syntax element indicating a first N bytes of the first SEI message.

17. The apparatus of claim 16, wherein the first SEI message is a T35 SEI message, wherein the T35 SEI message indicates at least a country code.

18. The apparatus of claim 11, wherein the apparatus is further configured to:
decode a prefix present flag, wherein the prefix present flag indicates if a prefix syntax element is present in the SEI processing order SEI message, the prefix syntax element indicating prefix bits or prefix bytes for the first SEI message; and
decode the prefix syntax element based on the prefix present flag.

19. The apparatus of claim 18, wherein the prefix syntax element indicates a value of a prefix bit for the first SEI message, and wherein the apparatus is further configured to:
decode a number of prefix bits syntax element that indicates a number of prefix syntax elements that are present in the SEI processing order SEI message.

20. The apparatus of claim 18, wherein the prefix syntax element indicates a value of a prefix byte for the first SEI message, and wherein the apparatus is further configured to:
decode a number of prefix bytes syntax element that indicates a number of prefix syntax elements that are present in the SEI processing order SEI message.

21. A method of processing video data, the method comprising:
generating a supplemental enhancement information (SEI) processing order SEI message;
encoding a first syntax element in the SEI processing order SEI message, the first syntax element indicating a preferred processing order of a first SEI message present in a bitstream; and
encoding a second syntax element in the SEI processing order SEI message, the second syntax element indicating the preferred processing order of a second SEI message present in the bitstream, wherein the first syntax element and the second syntax element have different values.

22. The method of claim 21, further comprising:
encoding an SEI payload type syntax element using a first encoding technique, and
wherein encoding the first syntax element comprises encoding the first syntax element using the first encoding technique.

23. The method of claim 22, wherein the first encoding technique is a 16-bit unsigned integer (u(16)) encoding technique.

24. The method of claim 21, further comprising:
encoding a third syntax element indicating a first N bytes of the first SEI message.

25. The method of claim 21, further comprising:
encoding a prefix present flag, wherein the prefix present flag indicates if a prefix syntax element is present in the SEI processing order SEI message, the prefix syntax element indicating prefix bits or prefix bytes for the first SEI message; and
encoding the prefix syntax element based on the prefix present flag.

26. An apparatus configured to process video data, the apparatus comprising:
a memory configured to store the video data; and
one or more processors coupled to the memory, wherein the apparatus is configured to:
generate a supplemental enhancement information (SEI) processing order SEI message;
encode a first syntax element in the SEI processing order SEI message, the first syntax element indicating a preferred processing order of a first SEI message present in a bitstream; and
encode a second syntax element in the SEI processing order SEI message, the second syntax element indicating the preferred processing order of a second SEI message present in the bitstream, wherein the first syntax element and the second syntax element have different values.

27. The apparatus of claim 26, wherein the apparatus is further configured to:
encode an SEI payload type syntax element using a first encoding technique, and
wherein to encode the first syntax element, the apparatus is configured to encode the first syntax element using the first encoding technique.

28. The apparatus of claim 27, wherein the first encoding technique is a 16-bit unsigned integer (u(16)) encoding technique.

29. The apparatus of claim 26, wherein the apparatus is further configured to:
encode a third syntax element indicating a first N bytes of the first SEI message.

30. The apparatus of claim 26, wherein the apparatus is further configured to:
encode a prefix present flag, wherein the prefix present flag indicates if a prefix syntax element is present in the SEI processing order SEI message, the prefix syntax element indicating prefix bits or prefix bytes for the first SEI message; and
encode the prefix syntax element based on the prefix present flag.
